(19) United States
(12) Patent Application Publication
(10) Pub. No.: US 2015/0356802 A1
(43) Pub. Date: Dec. 10, 2015

(54) Low Power Door-Lock Apparatus Based On Battery Using Face Recognition

(71) Applicant: Center For Integrated Smart Sensors Foundation, Daefeon (KR)

(72) Inventors: Hyun Tae Cho, Daejeon (KR); Chong Min Kyung, Daejeon (KR)

(21) Appl. No.: 14/734,356

(22) Filed: Jun. 9, 2015

(30) Foreign Application Priority Data
Jun. 10, 2014 (KR) 20-2014-0070051

(51) Int. Cl. G07C 9/00; G05B 15/02; E05B 47/00

(52) U.S. Cl. CPC G07C 9/00563; E05B 47/0001; G05B 15/02

(57) ABSTRACT

A door-lock apparatus based on battery is provided. The door-lock apparatus includes a CIS configured to obtain an optical signal and to convert the obtained optical signal into a digital image signal, an ISP configured to process the digital image signal to generate image data, a detector configured to be activated according to an operation of the ISP and to detect information about an object from the image data, a memory configured to store and maintain information about a reference object, a controller configured to compare the information about the object with the information about the reference object and to control a locking/unlocking state of the door-lock apparatus, and a door opening and closing unit configured to be controlled by the controller and to convert the door-lock apparatus from the locking state to the unlocking state.

### CROSS-REFERENCE TO RELATED APPLICATIONS

A claim for priority under 35 U.S.C. §119 is made to Korean Patent Application No. 10-2014-0070051 filed Jun. 10, 2014, in the Korean Intellectual Property Office, the entire contents of which are hereby incorporated by reference.

### BACKGROUND

Embodiments of the inventive concepts described herein relate to a low power door-lock apparatus based on a battery using face recognition, and more particularly, to technology for usually maintaining a low power mode in which a door-lock apparatus operates only a camera module, and for operating the door-lock apparatus in a normal mode by activating a module for object recognition only when an object appears in front of the door-lock apparatus.

Since a conventional door-lock apparatus based on a battery operates irrespective of a low power mode for reducing power consumption and a normal mode, there is an issue in that power consumption occurs by a module for object recognition.

Therefore, proposed is technology of usually operating only a camera module and activating a module for object recognition in response to a push of a user on a switch. However, the described door-lock apparatus has an inconvenience in which the user must push the switch.

Therefore, there is a need for technology which minimizes battery power consumption by usually maintaining a low power mode of operating only a camera module, and operating the door-lock apparatus in a normal mode by automatically activating a module for object recognition when an object appears in front of the door-lock apparatus

### SUMMARY

Embodiments of the inventive concepts provide a door-lock apparatus for usually maintaining an activated mode (normal mode) of operating only a camera module, and for operating in a normal mode by automatically activating a module for object recognition when an object appears in front of the door lock apparatus and an operation method thereof.

Embodiments of the inventive concepts provide a door-lock apparatus for controlling a locking/unlocking state according to a selective operation of a module for object recognition and an operation thereof.

Embodiments of the inventive concepts provide a door-lock apparatus which includes a camera module configured with at least one of a complementary metal oxide semiconductor (CMOS) image sensor (CIS), an image signal processor (ISP), or a detector and an operation method thereof.

Embodiments of the inventive concepts provide a door-lock apparatus for determining that an object appears in front of the door-lock apparatus, using one of a camera module, a switch, and a proximity sensor and an operation method thereof.

One aspect of embodiments of the inventive concept is directed to provide a door-lock apparatus based on a battery. The door-lock apparatus may include a complementary metal oxide semiconductor (CMOS) image sensor (CIS) configured to obtain an optical signal and to convert the obtained optical signal into a digital image signal, an image signal processor (ISP) configured to process the digital image signal to generate image data, a detector configured to be activated according to an operation of the ISP and to detect information about an object from the image data, a memory configured to store and maintain information about a reference object, a controller configured to compare the information about the object with the information about the reference object and to control a locking/unlocking state of the door-lock apparatus, and a door opening and closing unit configured to be controlled by the controller and to convert the door-lock apparatus from the locking state to the unlocking state.

Each of the memory and the controller may be activated according to at least one of an operation of the ISP or an operation of the detector.

The ISP may include an ISP memory configured to store and maintain previous image data generated by the ISP. The detector may be activated in response to receiving a result signal of comparing the image data generated by the ISP with the previous image data stored in the ISP memory from the ISP.

The ISP may include an ISP memory configured to store and maintain image data for a background image. The detector may be activated in response to receiving a result signal of comparing the image data generated by the ISP with the image data for the background image, which are stored in the ISP memory, from the ISP.

The detector may be activated according to an operation of a proximity sensor included in the door-lock apparatus.

Each of the CIS and the ISP may be activated in response to a push of a user on a switch included in the door-lock apparatus.

When the information about the object is identical to the information about the reference object, the controller may convert the door-lock apparatus from the locking state to the unlocking state using the door opening and closing unit.

The door-lock apparatus may further include a communication unit configured to communicate with an access point (AP) which is placed within a predetermined range of the door-lock apparatus. When the information about the object is not identical to the information about the reference object, the controller may transmit the information about the object to a user terminal through the communication unit.

The door-lock apparatus may further include an infrared emitting diode (WED) configured to emit light such that the CIS processes an infrared signal.

The IRED may be activated according to at least one of an operation of a proximity sensor included in the door-lock apparatus or a push of a user on a switch included in the door-lock apparatus.

Another aspect of embodiments of the inventive concept is directed to provide a door-lock apparatus based on a battery. The door-lock apparatus may include a complementary metal oxide semiconductor (CMOS) image sensor (CIS) configured to obtain an optical signal and to convert the obtained optical signal into a digital image signal, an image signal processor (ISP) configured to be activated according to an operation of the CIS and to process the digital image signal to generate image data, a detector configured to detect information about an object from the image data, a memory configured to store and maintain information about a reference object, a controller configured to compare the information about the object with the information about the reference object and to control a locking/unlocking state of the door-lock apparatus, and a door opening and closing unit configured to be controlled by the controller and to convert the door-lock apparatus from the locking state to the unlocking state.

The detector may be activated according to at least one of an operation of the CIS or an operation of the ISP. Each of the memory and the controller may be activated according to at least one of an operation of the CIS or an operation of the detector.

The CIS may include a CIS memory configured to store and maintain a previous digital image signal converted by the CIS. The ISP may be activated in response to receiving a result signal of comparing the digital image signal converted by the CIS with the previous digital image signal stored in the CIS memory from the CIS.

The CIS may include a CIS memory configured to store and maintain a digital image signal for a background image. The ISP may be activated in response to receiving a result signal of comparing the digital image signal converted by the CIS with the digital image signal for the background image, which is stored in the CIS memory, from the CIS.

The ISP may be activated according to an operation of a proximity sensor included in the door-lock apparatus.

The CIS may be activated in response to a push of a user on a switch included in the door-lock apparatus.

Another aspect of embodiments of the inventive concept is directed to provide a door-lock apparatus based on a battery. The door-lock apparatus may include a complementary metal oxide semiconductor (CMOS) image sensor (CIS) configured to obtain an optical signal and to convert the obtained optical signal into a digital image signal, an image signal processor (ISP) configured to process the digital image signal to generate image data, a detector configured to detect information about an object from the image data, a memory configured to store and maintain information about a reference object, a controller configured to compare the information about the object with the information about the reference object and to control a locking/unlocking state of the door-lock apparatus, and a door opening and closing unit configured to be controlled by the controller and to convert the door-lock apparatus from the locking state to the unlocking state. Each of the memory and the controller may be activated according to an operation of the detector.

The ISP may include an ISP memory configured to store and maintain previous image data generated by the ISP. The detector may be activated in response to receiving a result signal of comparing the image data generated by the ISP with the previous image data stored in the ISP memory from the ISP.

The ISP may include an ISP memory configured to store and maintain image data for a background image. The detector may be activated in response to receiving a result signal of comparing the image data generated by the ISP with the image data for the background image, which are stored in the ISP memory, from the ISP.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a drawing illustrating a door-lock apparatus based on a battery according to an exemplary embodiment of the inventive concept;

FIG. 2 is a block diagram illustrating a configuration of a door-lock apparatus based on a battery according to an exemplary embodiment of the inventive concept;

FIG. 3 is a block diagram illustrating a configuration of a door-lock apparatus based on a battery according to another exemplary embodiment of the inventive concept;

FIG. 4 is a block diagram illustrating a configuration of a door-lock apparatus based on a battery according to another exemplary embodiment of the inventive concept;

FIG. 5 is a flowchart illustrating an operation method of a door-lock apparatus according to an exemplary embodiment of the inventive concept;

FIG. 6 is a flowchart illustrating an operation method of a door-lock apparatus according to another exemplary embodiment of the inventive concept;

FIG. 7 is a flowchart illustrating an operation method of a door-lock apparatus according to another exemplary embodiment of the inventive concept;

FIG. 8 is a block diagram illustrating a configuration of a door-lock apparatus when information about a reference object is stored according to an exemplary embodiment of the inventive concept; and

FIG. 9 is a flowchart illustrating an operation of a door-lock apparatus when information about a reference object is stored according to an exemplary embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Hereinafter, a description will be given in detail for exemplary embodiments of the inventive concept with reference to the accompanying drawings. However, the inventive concept is not limited to exemplary embodiments. Also, like reference numerals denote like elements.

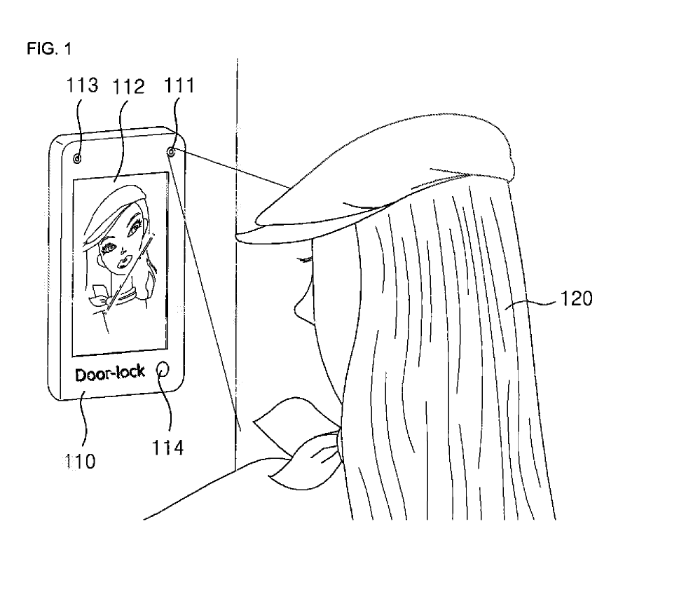

FIG. 1 is a drawing illustrating a door-lock apparatus based on a battery according to an exemplary embodiment of the inventive concept.

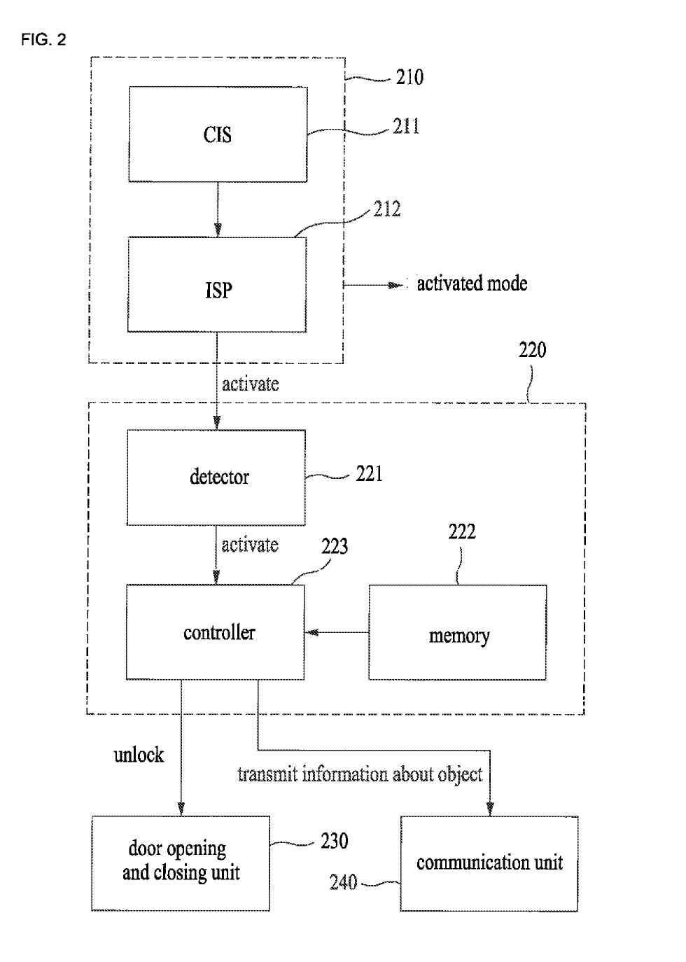

Referring to FIG. 1, a door-lock apparatus 110 according to an exemplary embodiment of the inventive concept may include a camera 111 which is attached to a front surface of the door-lock apparatus 110, a display unit 112 for setting a menu and identifying an image, a complementary metal oxide semiconductor (CMOS) image sensor (CIS) (not shown), an image signal processor (ISP) (not shown), a detector (not shown), a memory (not shown), a controller (not shown), and a communication unit (not shown) which are installed in the door-lock apparatus 110, and a door opening and closing unit (not shown) which is controlled by the controller and changes the door-lock apparatus 110 from a locking state to an unlocking state. Exemplary embodiments of the door-lock apparatus 110 may include an exemplary embodiment which includes a CIS and an ISP as a camera module which usually operates, another exemplary embodiment which includes only a CIS as a camera module, and another exemplary embodiment which includes a CIS, an ISP, and a detector as a camera module. A detailed description will be given of exemplary embodiments of the inventive concept with reference to FIGS. 2 to 4.

According to exemplary embodiments of the inventive concept, the door-lock apparatus 110 may usually maintain activated mode (normal mode) of operating only a camera module. When an object 120 appears in front of the door-lock apparatus 110, the door-lock apparatus 110 may automatically activates a module for object recognition to operate in a normal mode. In this case, the module for object recognition may be configured to include a detector, a memory, and a controller in an exemplary embodiment of the inventive concept. The module for object recognition may be configured to include an ISP, a detector, a memory, and a controller in another exemplary embodiment of the inventive concept. The module for object recognition may be configured to include a memory and a controller in another exemplary embodiment of the inventive concept.

Therefore, the door-lock apparatus 110 which operates based on its battery may control its locking/unlocking state using lower power than that of a conventional door-lock apparatus by selectively driving the module for object recognition. In this case, since the door-lock apparatus 110 automatically determines that the object 120 appears in front of the door-lock apparatus 110 using the camera module, it may address an inconvenience in that a user must push a switch included in the door-lock apparatus 110.

Also, the door-lock apparatus 110 may determine that the object 120 appears in front of the door-lock apparatus 110 using a proximity sensor 113 or a switch 114. For example, the door-lock apparatus 110 may determine that the object 120 appears in front of the door-lock apparatus 110, according to an operation of the proximity sensor 113 or a push of a user on the switch 114 and may selectively drive the module for object recognition.

The camera module may also be driven in response to a push of the user on the switch 114 or an operation of the proximity sensor 113. For example, each of the camera module and the module for object recognition of the door-lock apparatus 110 may usually maintain an inactive state. When the user pushes the switch 114 or when it is sensed that the user uses the door-lock apparatus 110 by the proximity sensor 113, each of the camera module and the module for object recognition may be converted into an active state to be driven.

Also, although not illustrated, the door-lock apparatus 110 may further include an infrared emitting diode (IRED) which emits light such that a CIS processes an infrared (IR) signal. Herein, the IRED may be activated according to at least one of an operation of the proximity sensor 113 included in the door-lock apparatus 110 or a push of the user on the switch 114 included in the door-lock apparatus 110. Therefore, the door-lock apparatus 110 may smoothly ascertain and recognize the object 120 in a dark peripheral state.

The display unit 112 may be installed on a front surface of the door-lock apparatus 110, and may be used to set a menu, to identify an image about the object 120 obtained by capturing, and to identify an image about a reference object stored in a memory (not shown). Also, when a door opening and closing unit operates according as the object 120 is recognized and when the door-lock apparatus 110 is changed from a locking state to an unlocking state, the display unit 112 may display a message for providing notification that the door-lock apparatus 110 is in the unlocking state. When the object 120 is not recognized, the display unit 112 may display a warning message for providing notification that the object 120 is not identical to a registered user. Alternatively, a warning sound may be reproduced through a speaker (not shown).

The communication unit (not shown) may communicate with an access point (AP) which is placed within a predetermined range. Thus, when the object 120 is not a registered user in a process of recognizing the object 120, the door-lock apparatus 110 may send a warning message to a user terminal through the communication unit. For example, when the object 120 is not the registered user, the door-lock apparatus 110 may transmit information about the object 120 (e.g., a face of the object 120) to the user terminal through the communication unit.

FIG. 2 is a block diagram illustrating a configuration of a door-lock apparatus based on a battery according to an exemplary embodiment of the inventive concept.

Referring to FIG. 2, a door-lock apparatus according to an exemplary embodiment of the inventive concept may include a CIS 211 and an ISP 212 as a camera module 210 which usually operates. The door-lock apparatus may include a detector 221, a memory 222, and a controller 223 as a module 220 for object recognition, which is selectively activated. The door-lock apparatus may include a door opening and closing unit 230 which is controlled by the controller 223 and changes the door-lock apparatus from a locking state to an unlocking state. Also, the door-lock apparatus may further include a communication unit 240.

The CIS 211 may obtain an optical signal using a camera attached to a front surface of the door-lock apparatus and may convert the obtained optical signal into a digital image signal. In this case, although not illustrated, the door-lock apparatus may further include an IRED which emits light such that the CIS 211 processes an IR signal. Herein, the IRED may be randomly activated according to brightness around the door-lock apparatus. For example, the IRED may usually maintain an inactive state, and may be selectively activated according to brightness of a previous optical signal obtained by the CIS 211. Also, the IRED may be selectively activated according to brightness of a previous optical signal obtained through a separate optical sensor.

Therefore, the IRED may be randomly activated only when peripheral brightness is dark and may emit light such that the CIS 211 smoothly operates in a state where peripheral brightness is dark. Also, the IRED may be activated according to at least one of an operation of a proximity sensor included in the door-lock apparatus or a push of a user on a switch included in the door-lock apparatus.

The ISP 212 may process the digital image signal transmitted from the CIS 211 to generate image data. For example, the ISP 212 may perform interpolation, color correction, gamma correction, noise reduction, or demosaic, and the like with respect to the digital image signal.

Herein, the CIS 211 and the ISP 212 may usually maintain an active state always, and may automatically determine that an object appears in front of the door-lock apparatus. In more detail, the ISP 212 may include an ISP memory which stores and maintains image data of a previous frame and may compare generated image data of a current frame with image data of a previous frame, which are stored in the ISP memory. When a change occurs between the image data of the current frame and the image data of the previous frame, the ISP 212 may automatically determine that an object appears in front of the door-lock apparatus.

Also, the ISP 212 may include an ISP memory which stores and maintains image data for a background image, and may compare generated image data with image data for a background image, which are stored in the ISP memory. When a change occurs between the generated image data and the image data stored in the ISP memory, the ISP 212 may automatically determine that an object appears in front of the door-lock apparatus.

As such, when it is determined that the object appears in front of the door-lock apparatus, the ISP 212 may activate the module 220 for object recognition. On the other hand, when it is determined that the object does not appear in front of the door-lock apparatus, the ISP 212 may maintain the module 220 for object recognition in an inactive state.

In this case, the CIS 211 and the ISP 212 may be selectively activated in response to a push of a user on a switch included in the door-lock apparatus or an operation of a proximity sensor included in the door-lock apparatus. For example, both of the CIS 211 and the ISP 212 may usually maintain a low power mode in an inactive state. When the user pushes the switch or when it is sensed that the user uses the door-lock apparatus by the proximity sensor, the CIS 211 and the ISP 212 may be activated.

The detector 221 may be activated according to an operation of the ISP 212, and may detect information about an object from image data. Herein, the information about the object may mean information (e.g., a shape, a size, and a position of each of eyes, a nose, a mouth, and ears) about a face of the object. In this case, the detector 221 may use a variety of algorithms as algorithms for detecting information about an object from image data. Since a detailed description for this is departed from the scope and spirit of the inventive concept, it will be omitted.

In this instance, wherein the CIS 211 and the ISP 212 maintain an activated mode always and bypass an image signal to the detector 221 when the CIS 211 and the ISP 212 do not include any detection function.

In more detail, the detector 221 may usually maintain an inactive state. The detector 221 may be activated in response to receiving a result signal of comparing image data of a current frame with image data of a previous frame from the ISP 212. Also, the detector 221 may usually maintain an inactive state. The detector 221 may be activated in response to receiving a result signal of comparing generated image data with image data for a background image, which are stored in the ISP memory, from the ISP 212.

For example, when it is determined that the object appears in front of the door-lock apparatus, the ISP 212 may transmits a result signal, for providing notification that the object appears in front of the door-lock apparatus, to the detector 221. The detector 221 may be changed from the inactive state to an active state in response to the result signal.

Also, the detector 221 may be activated according to an operation of the proximity sensor included in the door-lock apparatus, rather than being activated according to an operation of the ISP 212. For example, the detector 221 may be activated by receiving a signal, for providing notification that an object appears in front of the door-lock apparatus, from the proximity sensor, irrespective of operations of the CIS 211 and the ISP 212.

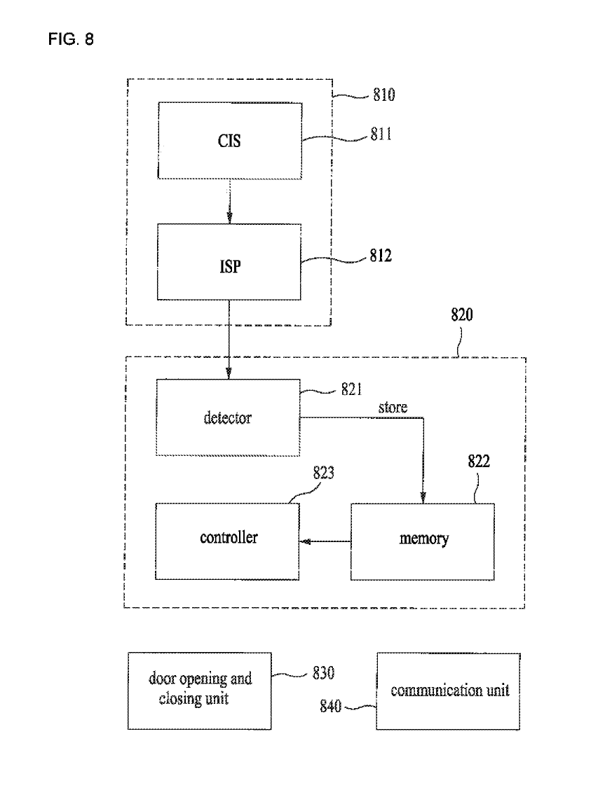

The memory 220 may store and maintain information about a reference object. Herein, the information about the reference object may be information about a previously registered user. When the door-lock apparatus uses face information of an object in a process of recognizing the object, the information about the reference object may be face information of a previously registered user. A detailed description for this will be given with reference to FIG. 8.

The controller 223 may compare the information about the object, which is transmitted from the detector 221, with the information about the reference object, which is stored in the memory 222 and may control a locking/unlocking state of the door-lock apparatus. In this case, the controller 223 may use various algorithms as algorithms for comparing the information about the object with the information about the reference object. Since a detailed description for this is departed from the scope and spirit of the inventive concept, it will be omitted.

In more detail, when the information about the object is identical to the information about the reference object, the controller 223 may convert the door-lock apparatus from the locking state to the unlocking state by operating the door opening and closing unit 230. Herein, the door opening and closing unit 230 may be a physical component for setting the locking/unlocking state of the door-locking apparatus and may be controlled by the controller 223.

On the other hand, when the information about the object is not identical to the information about the reference object, the controller 223 maintains the door opening and closing unit 230 in the locking state and may transmit the information about the object to a user terminal through the communication unit 240 included in the door-lock apparatus. In this case, since the communication unit 240 communicates with an AP which is placed within a predetermined range of the door-lock apparatus, the information about the object may be transmitted to the user terminal through the AP which is placed within the predetermined range. Also, the communication unit 240 may transmit the information about the object through a 3 generation (G) or long term evolution (LTE) communication network, rather than the AP which is placed within the predetermined range.

Also, the controller 223 may display a warning message, providing notification that an object is not a registered user, on a display unit included in the door-lock apparatus and may reproduce a warning sound through a speaker included in the door-lock apparatus.

Herein, the memory 222 and the controller 223 may usually maintain the inactive state, and may be activated according to at least one of an operation of the ISP 212 or an operation of the detector 221. For an example, the memory 222 and the controller 223 may be simultaneously activated with the detector 221 by being activated according to the operation of the ISP 212. For another example, as the memory 222 and the controller 223 are activated according to the operation of the detector 221, the detector 221, the memory 222, and the controller 223 may be activated in the order of the detector 221, the memory 222, and the controller 223 in the module 220 for object recognition.

Also, the memory 222 and the controller 223 may be activated according to an operation of the proximity sensor included in the door-lock apparatus, rather than being activated according to the operation of the ISP 212. For example, as the memory 222 and the controller 223 may be activated, irrespective of the operations of the CIS 211 and the ISP 212, by receiving a signal, for providing notification that an object appears in front of the door-lock apparatus, from the proximity sensor, the detector 221 may be activated according to an operation of the proximity sensor. In this case, the memory 222 and the controller 223 may be simultaneously activated with the detector 221.

Hereinafter, the description is given of the detector 221 and the controller 223 as separate components. The scope and spirit of the inventive concept may not be limited thereto. For example, there are detector 221 and the controller 223 as one component. In this case, the process of detecting the information about the object from the image data and the process of comparing the information about the object with the information about the reference object may be performed in one component.

As such, according to an exemplary embodiment of the inventive concept, the module 220 for object recognition including the detector 221, the memory 222, and the controller 223 may usually maintain the inactive state and may be selectively activated according to the operation of the camera module 210 including the CIS 211 and the ISP 212, thereby making it possible to reduce power consumption.

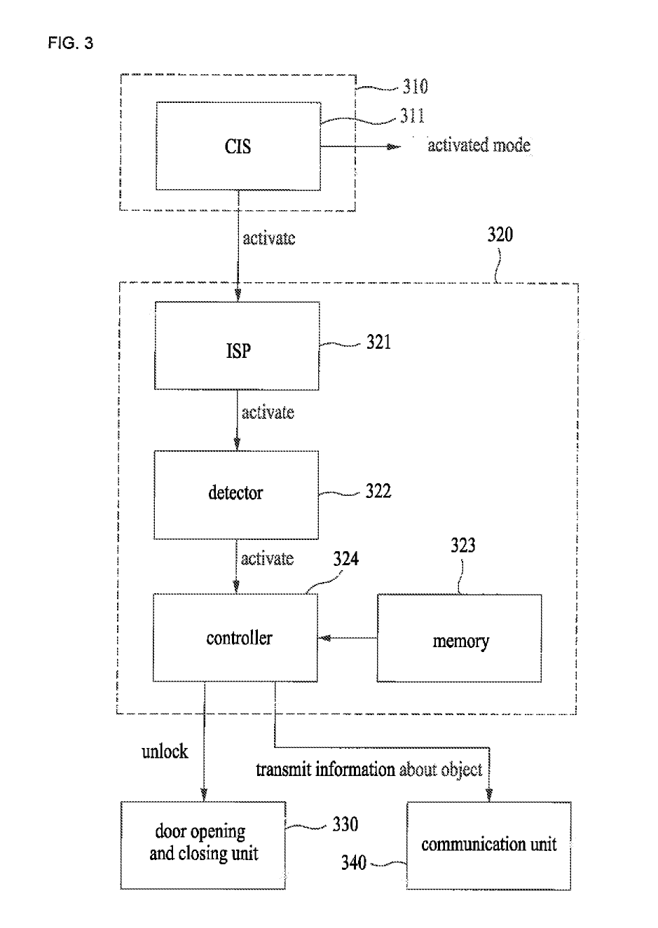

FIG. 3 is a block diagram illustrating a configuration of a door-lock apparatus based on a battery according to another exemplary embodiment of the inventive concept.

Referring to FIG. 3, a door-lock apparatus according to another exemplary embodiment of the inventive concept may include a CIS 311 as a camera module 310 which usually operates. The door-lock apparatus may include an ISP 321, a detector 322, a memory 323, and a controller 324 as a module 320 for object recognition, which is selectively activated. The door-lock apparatus may include a door opening and closing unit 330 which is controlled by the controller 223 and converts the door-lock apparatus from a locking state to an unlocking state. Also, the door-lock apparatus may further include a communication unit 340.

The CIS 311 may obtain an optical signal and may convert the obtained optical signal into a digital image signal. In this case, although not illustrated, the door-lock apparatus may further include an IRED which emits light such that the CIS 311 processes an IR signal. Herein, the IRED may perform the same operation as that of the IRED described in FIG. 1 according to an exemplary embodiment of the inventive concept.

Herein, the CIS 311 may usually maintain an active state always, and may automatically determine that an object appears in front of the door-lock apparatus. In more detail, the CIS 311 may include a CIS memory which stores and maintains a digital image signal of a previous frame and may compare a generated digital image signal of a current frame with a digital image signal of a previous frame, which is stored in the CIS memory. When a change occurs between the generated digital image signal of the current frame and the digital image signal of the previous frame, the CIS 311 may automatically determine that the object appears in front of the door-lock apparatus.

Also, the CIS 311 may include a CIS memory which stores and maintains a digital image signal for a background image and may compare a converted digital image signal with a digital image signal for a background image, which is stored in the CIS memory. When a change occurs between the converted digital image signal and the digital image signal for the background image, the CIS 311 may determine that the object appears in front of the door-lock apparatus.

As such, when it is determined that the object appears in front of the door-lock apparatus, the CIS 311 may activate the module 320 for object recognition. On the other hand, when it is determined that the object does not appear in front of the door-lock apparatus, the CIS 311 may maintain the module 320 for object recognition in an inactive state.

In this case, the CIS 311 may be selectively activated in response to a push of a user on a switch included in the door-lock apparatus or an operation of a proximity sensor included in the door-lock apparatus. For example, the CIS 311 may usually maintain a low power mode in the inactive state. When the user pushes the switch or when it is sensed that the user uses the door-lock apparatus by the proximity sensor, the CIS 311 may be activated.

The ISP 321 may be activated according to an operation of the CIS 311 and may process the digital image signal transmitted from the CIS 311 to generate image data. For example, the ISP 321 may perform interpolation, color correction, gamma correction, noise reduction, or demosaic, and the like with respect to the digital image signal.

In more detail, the ISP 321 may usually maintain an inactive state, and may be activated in response to receiving a result signal of comparing a digital image signal of a current frame with a digital image signal of a previous frame from the CIS 311. Also, the ISP 321 may usually maintain the inactive state, and may be activated in response to receiving a result signal of comparing a converted digital image signal with a digital image signal for a background image, which is stored in the CIS memory, from the CIS 311.

For example, when it is determined that the object appears in front of the door-lock apparatus, the CSI 311 may transmit a result signal, for providing notification that the object appears in front of the door-lock apparatus, to the ISP 321. The ISP 321 may be converted from the inactive state to an active state in response to the result signal.

Also, the ISP 321 may be activated according to an operation of the proximity sensor included in the door-lock apparatus, rather than being activated according to the operation of the CIS 311. For example, the ISP 321 may be activated, irrespective of the operation of the CIS 311, by receiving a signal, for providing notification that the object appears in front of the door-lock apparatus, from the proximity sensor.

The detector 322 may detect information about an object from the image data. Herein, the information about the object may mean information about a face of the object. In this case, the detector 322 may use a variety of algorithms as algorithms for detecting information about the object from the image data. Since a detailed description for this is departed from the scope and spirit of the inventive concept, it will be omitted.

The memory 323 may store and maintain information about a reference object. Herein, the information about the reference object may be information about a previously registered user. When the door-lock apparatus uses face information of an object in a process of recognizing the object, the information about the reference object may be face information of a previously registered user. A detailed description for this will be given with reference to FIG. 8.

The controller 324 may compare the information about the object, which is transmitted from the detector 221, with the information about the reference object, which is stored in the memory 323 and may control a locking/unlocking state of the door-lock apparatus. In this case, the controller 324 may use various algorithms as algorithms for comparing the information about the object with the information about the reference object. Since a detailed description for this is departed from the scope and spirit of the inventive concept, it will be omitted.

In more detail, when the information about the object is identical to the information about the reference object, the controller 324 may convert the door-lock apparatus from the locking state to the unlocking state by operating the door opening and closing unit 330. Herein, the door opening and closing unit 330 may be a physical component for setting the locking/unlocking state of the door-locking apparatus and may be controlled by the controller 324.

On the other hand, when the information about the object is not identical to the information about the reference object, the controller 324 may maintain the door opening and closing unit 330 in the locking state and may transmit information about the object to a user terminal through the communication unit 340 included in the door-lock apparatus. In this case, since the communication unit 340 communicates with an AP which is placed within a predetermined range of the door-lock apparatus, the information about the object may be transmitted to the user terminal through the AP which is placed within the predetermined range. Also, the communication unit 340 may the information about the object to the user terminal through a 3G or LTE communication network, rather than the AP which is placed within the predetermined range.

Also, the controller 324 may display a warning message, providing notification that an object is not a registered user, on a display unit included in the door-lock apparatus and may reproduce a warning sound through a speaker included in the door-lock apparatus.

Herein, the detector 322 may usually maintain an inactive state, and may be activated according to at least one of an operation of the CIS 311 or an operation of the ISP 321. For an example, the detector 322 may be simultaneously activated with the ISP 321 by being activated according to the operation of the CIS 311. For another example, as the detector 322 is activated according to the operation of the ISP 321, the ISP 321 and the detector 322 may be successively activated in the order of the ISP 321 and the detector 322 in the module 320 for object recognition.

Also, the memory 323 and the controller 324 may usually maintain the inactive state, and may be activated according to at least one of an operation of the CIS 311 or an operation of the detector 322. For an example, the memory 323 and the controller 324 may be simultaneously activated with the ISP 321 and the detector 322 by being activated according to the operation of the CIS 311. For another example, as the memory 323 and the controller 324 are activated according to the operation of the detector 322, the ISP 321, the detector 322, the memory 323, and the controller 324 may be activated in the order of the ISP 321, the detector 322, the memory 323, and the controller 324 in the module 320 for object recognition.

Also, the detector 322, the memory 323, and the controller 324 may be activated according to an operation of a proximity sensor included in the door-lock apparatus, rather than being activated according to the operation of the CIS 311. For example, as the detector 322, the memory 323, and the controller 324 may be activated, irrespective of the operations of the CIS 311, by receiving a signal, for providing notification that the object appears in front of the door-lock apparatus, from the proximity sensor, the ISP 321 is activated according to an operation of the proximity sensor. Therefore, the detector 322, the memory 323, and the controller 324 may be simultaneously activated with the ISP 321.

Hereinafter, the description is given of the detector 322 and the controller 324 as separate components. The scope and spirit of the inventive concept may not be limited thereto. For example, there are the detector 322 and the controller 324 as one component. In this case, the process of detecting the information about the object from the image data and the process of comparing the information about the object with the information about the reference object may be performed in one component.

As such, according to another exemplary embodiment of the inventive concept, the module 320 for object recognition including the ISP 321, the detector 322, the memory 323, and the controller 324 may usually maintain the inactive state and may be selectively activated according to the operation of the camera module 310 including the CIS 311, thereby making it possible to reduce power consumption.

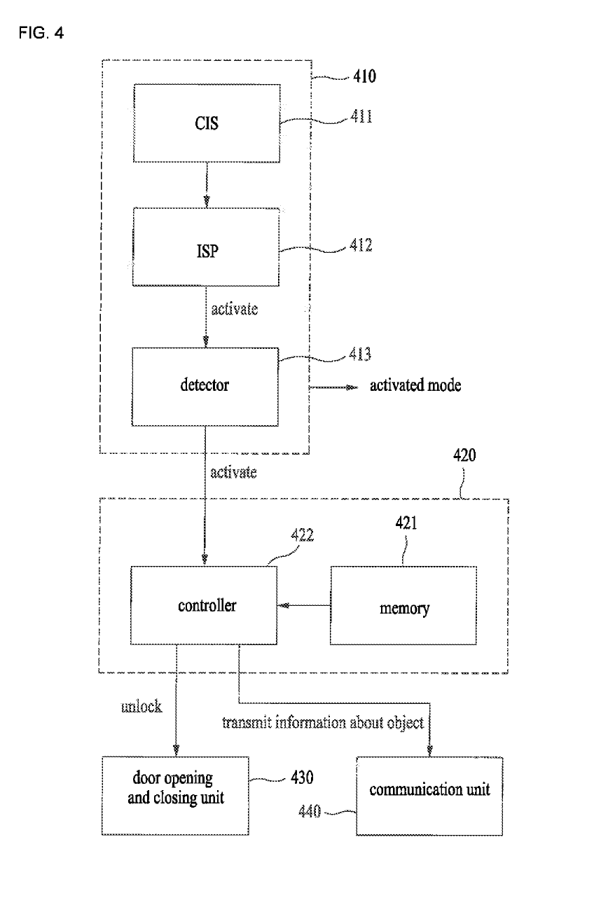

FIG. 4 is a block diagram illustrating a configuration of a door-lock apparatus based on a battery according to another exemplary embodiment of the inventive concept.

Referring to FIG. 4, a door-lock apparatus according to another exemplary embodiment of the inventive concept may include a CIS 411, an ISP 412, and a detector 413 as a camera module 410 which usually operates. The door-lock apparatus may include a memory 421 and a controller 422 as a module 420 for object recognition, which is selectively activated. The door-lock apparatus may include a door opening and closing unit 430 which is controlled by the controller 223 and converts the door-lock apparatus from a locking state to an unlocking state. Also, the door-lock apparatus may further include a communication unit 440.

The CIS 411 may obtain an optical signal and may convert the obtained optical signal into a digital image signal. In this case, although not illustrated, the door-lock apparatus may further include an IRED which emits light such that the CIS 411 processes an IR signal. Herein, the IRED may perform the same operation as that of an IRED described in FIG. 1 according to an exemplary embodiment of the inventive concept. The ISP 412 may process the digital image signal transmitted from the CIS 411 to generate image data. For example, the ISP 412 may perform interpolation, color correction, gamma correction, noise reduction, or demosaic, and the like with respect to the digital image signal.

The detector 413 may detect information about an object from the image data. Herein, the information about the object may mean information about a face of the object.

Herein, the CIS 411, the ISP 412, and the detector 413 may usually maintain an active state always, and may automatically determine that an object appears in front of the door-lock apparatus. In more detail, the detector 413 may automatically determine that the object appears in front of the door-lock apparatus according to whether to detect the information about the object from the image data. In more detail, when the information about the object is detected from the image data, the detector 413 may automatically determine that the object appears in front of the door-lock apparatus.

As such, when it is determined that the object appears in front of the door-lock apparatus, the detector 413 may activate the module 420 for object recognition. On the other hand, when it is determined that the object does not appear in front of the door-lock apparatus, the detector 413 may maintain the module 420 for object recognition in an inactive state.

In this case, the CIS 411, the ISP 412, and the detector 413 may be selectively activated in response to a push of a user on a switch included in the door-lock apparatus or an operation of a proximity sensor included in the door-lock apparatus. For example, the CIS 411, the ISP 412, and the detector 413 may usually maintain a low power mode in the inactive state. When the user pushes the switch or when it is sensed that the user uses the door-lock apparatus by the proximity sensor, the CIS 411, the ISP 412, and the detector 413 may be activated.

The memory 421 may store and maintain information about a reference object. Herein, the information about the reference object may be information about a previously registered user. When the door-lock apparatus uses face information of an object in a process of recognizing the object, the information about the reference object may be face information of a previously registered user. A detailed description for this will be given with reference to FIG. 8.

The controller 422 may compare the information about the object, which is transmitted from the detector 413, with the information about the reference object, which is stored in the memory 421 and may control a locking/unlocking state of the door-lock apparatus. In this case, the controller 422 may use various algorithms as algorithms for comparing the information about the object with the information about the reference object. Since a detailed description for this is departed from the scope and spirit of the inventive concept, it will be omitted.

In more detail, when the information about the object is identical to the information about the reference object, the controller 422 may convert the door-lock apparatus from the locking state to the unlocking state by operating the door opening and closing unit 430. Herein, the door opening and closing unit 430 may be a physical component for setting the locking/unlocking state of the door-locking apparatus and may be controlled by the controller 422.

On the other hand, when the information about the object is not identical to the information about the reference object, the controller 422 maintains the door opening and closing unit 430 in the locking state and may transmit the information about the object to a user terminal through the communication unit 440 included in the door-lock apparatus. In this case, since the communication unit 440 communicates with an AP which is placed within a predetermined range of the door-lock apparatus, the information about the object may be transmitted to the user terminal through the AP which is placed within the predetermined range. Also, the communication unit 440 may transmit the information about the object through a 3G or LTE communication network, rather than the AP which is placed within the predetermined range.

Herein, the memory 421 and the controller 422 may usually maintain the inactive state, and may be activated according to an operation of the detector 413. For an example, the memory 421 and the controller 422 may usually maintain the inactive state, and may be activated in response to receiving a result signal indicating whether the information about the object is detected from the image data from the detector 413.

For example, when it is determined that the object appears in front of the door-lock apparatus, the detector 413 may transmit a result signal, for providing notification that the object appears in front of the door-lock apparatus, to the memory 421 and the controller 422. The memory 421 and the controller 422 may be converted from the inactive state to an active state in response to the result signal.

Also, the memory 421 and the controller 422 may be activated according to an operation of a proximity sensor included in the door-lock apparatus, rather than being activated according to an operation of the detector 413. For example, the memory 421 and the controller 422 may be activated, irrespective of the operation of the detector 413, by receiving a signal, for providing notification that the object appears in front of the door-lock apparatus, from the proximity sensor.

Hereinafter, the description is given of the ISP 412 and the detector 413 as separate components. The scope and spirit of the inventive concept may not be limited thereto. For example, there are the ISP 412 and the detector 413 as one component. In this case, the process of detecting the information about the object from the image data and the process of comparing the information about the object with the information about the reference object may be performed in one component.

As such, according to another exemplary embodiment of the inventive concept, the module 420 for object recognition including the memory 421 and the controller 422 may usually maintain the inactive state and may be selectively activated according to the operation of the camera module 410 including the CIS 411, the ISP 412, and the detector 413, thereby making it possible to reduce power consumption.

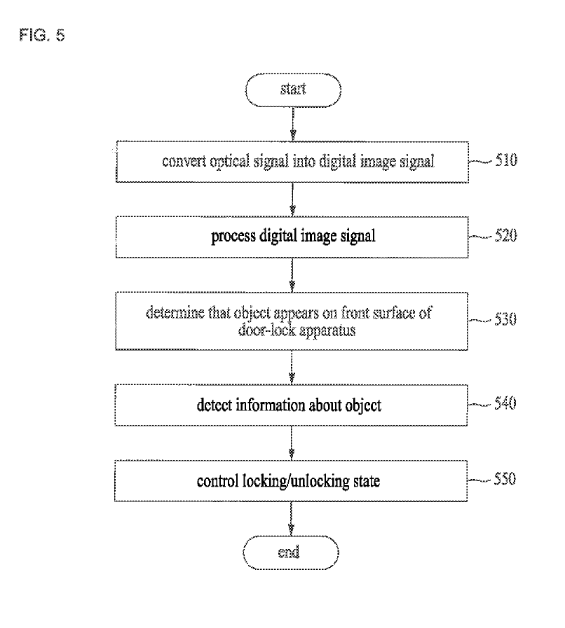

FIG. 5 is a flowchart illustrating an operation method of a door-lock apparatus according to an exemplary embodiment of the inventive concept.

Referring to FIG. 5, in step 510, a CIS which is in an active state in a door-lock apparatus according to an exemplary embodiment of the inventive concept may obtain an optical signal and may convert the obtained optical signal into a digital image signal. In this case, when peripheral brightness is dark, the door-lock apparatus may selectively activate an IRED such that the CIS smoothly obtains an optical signal.

In step 520, an ISP which is in the active state in the door-lock apparatus may process the digital image signal to generate image data.

Herein, the CIS and the ISP may usually maintain the active state always. On the other hand, the CIS and the ISP may usually maintain a low power mode in an inactive state and may be activated when a user pushes a switch included in the door-lock apparatus.

In this case, in step 530, the door-lock apparatus may automatically determine that an object appears in front of the door-lock apparatus using the CIS and the ISP, by usually maintaining the CIS and the ISP in the active state. For example, the door-lock apparatus may automatically determine that an object appears in front of the door-lock apparatus, by comparing image data of a previous frame, which are stored in an ISP memory included in the ISP, with current image data generated by the ISP. Also, the door-lock apparatus may automatically determine that an object appears in front of the door-lock apparatus, by comparing image data of a background image, which are stored in the ISP memory included in the ISP, with image data generated by the ISP.

Also, the door-lock apparatus may automatically determine that an object appears in front of the door-lock apparatus, using a proximity sensor included in the door-lock apparatus, rather than using the CIS and ISP.

The door-lock apparatus may activate a module for object recognition. In more detail, the door-lock apparatus may activate a detector. In step 540, the detector may detect information about the object from the image data.

Also, the door-lock apparatus may activate a memory which stores and maintains information about a reference object and may activate a controller. In step 550, the controller may compare the information about the object with information about a reference object and may control a locking/unlocking state of the door-lock apparatus. For example, when the information about the object is identical to the information about the reference object, the door-lock apparatus may be converted from the locking state to the unlocking state by a door opening and closing unit. When the information about the object is not identical to the information about the reference object, the door-lock apparatus may be maintained in the locking state by the door opening and closing unit, and may transmit the information about the object to a user terminal through a communication unit which communicates with an AP which is placed within a predetermined range.

Herein, the detector, the memory, and the controller may be simultaneously or successively activated in response to determining that the object appears in front of the door-lock apparatus.

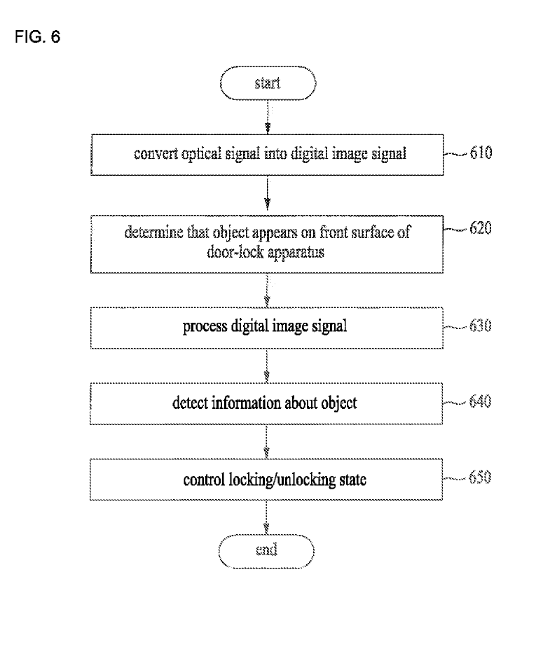

FIG. 6 is a flowchart illustrating an operation method of a door-lock apparatus according to another exemplary embodiment of the inventive concept.

Referring to FIG. 6, in step 610, a CIS which is in an active state in a door-lock apparatus according to another exemplary embodiment of the inventive concept may obtain an optical signal and may convert the obtained optical signal into a digital image signal. In this case, when peripheral brightness is dark, the door-lock apparatus may selectively activate an IRED such that the CIS smoothly obtains an optical signal.

Herein, the CIS may usually maintain the active state always. On the other hand, the CIS may usually maintain a low power mode in an inactive state, and may be activated when a user pushes a switch included in the door-lock apparatus.

In this case, in step 620, the door-lock apparatus may automatically determine that an object appears in front of the door-lock apparatus using the CIS, by usually maintaining the CIS in the active state. For example, the door-lock apparatus may automatically determine that an object appears in front of the door-lock apparatus, by comparing a digital image signal of a previous frame, which is stored in a CIS memory included in the CIS, with a current image signal generated by the CIS. Also, the door-lock apparatus may automatically determine that an object appears in front of the door-lock apparatus, by comparing a digital image signal of a background image, which are stored in the CSI memory included in the CIS, with a digital image signal converted by the CIS.

Also, the door-lock apparatus may automatically determine that an object appears in front of the door-lock apparatus, using a proximity sensor included in the door-lock apparatus, rather than using the CIS.

The door-lock apparatus may activate a module for object recognition. In more detail, the door-lock apparatus may activate an ISP. In step 630, the ISP may process the digital image signal to generate image data.

In step 640, a detector of the door-lock apparatus may detect information about the object from the image data.

Also, the door-lock apparatus may activate a memory which stores and maintains information about a reference object and may activate a controller. In step 650, the controller may compare the information about the object with information about a reference object and may control a locking/unlocking state of the door-lock apparatus. For example, when the information about the object is identical to the information about the reference object, the door-lock apparatus may be converted from the locking state to the unlocking state by a door opening and closing unit. When the information about the object is not identical to the information about the reference object, the door-lock apparatus may be maintained in the locking state by the door opening and closing unit, and may transmit the information about the object to a user terminal through a communication unit which communicates with an AP which is placed within a predetermined range.

Herein, the ISP, the detector, the memory, and the controller may be simultaneously or successively activated in response to determining that the object appears in front of the door-lock apparatus.

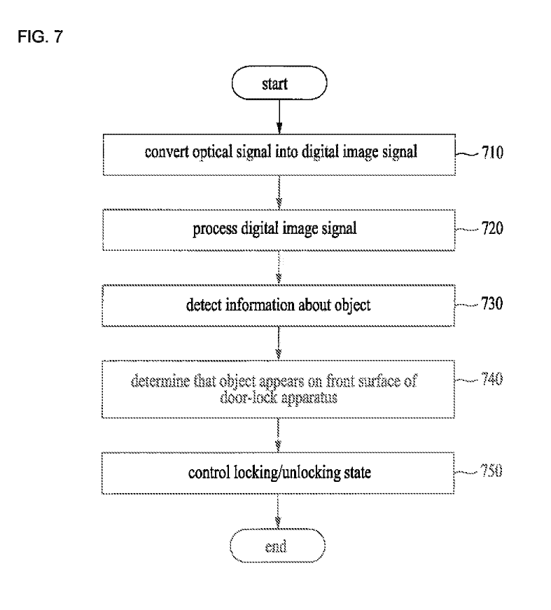

FIG. 7 is a flowchart illustrating an operation method of a door-lock apparatus according to another exemplary embodiment of the inventive concept.

Referring to FIG. 7, in step 710, a CIS which is in an active state in a door-lock apparatus according to another exemplary embodiment of the inventive concept may obtain an optical signal and may convert the obtained optical signal into a digital image signal. In this case, when peripheral brightness is dark, the door-lock apparatus may selectively activate an WED such that the CIS smoothly obtains an optical signal.

In step 720, an ISP which is in the active state in the door-lock apparatus may process the digital image signal to generate image data.

In step 730, a detector which is the active state in the door-lock apparatus may detect information about an object from the image data.

Herein, the CIS, the ISP, and the detector may usually maintain the active state always. On the other hand, the CIS, the ISP, and the detector may usually maintain a low power mode in an inactive state, and may be activated when a user pushes a switch included in the door-lock apparatus.

In this case, in step 740, the door-lock apparatus may automatically determine that an object appears in front of the door-lock apparatus using the detector, by usually maintaining the CIS, the ISP, and the detector in the active state. For example, the door-lock apparatus may automatically determine that an object appears in front of the door-lock apparatus, according to whether to detect information about the object from image data.

Also, the door-lock apparatus may automatically determine that an object appears in front of the door-lock apparatus, using a proximity sensor included in the door-lock apparatus, rather than using the detector.

The door-lock apparatus may activate a module for object recognition. In more detail, the door-lock apparatus may activate a memory which stores and maintains information about a reference object and may activate a controller. In step 750, the controller may compare the information about the object with information about a reference object and may control a locking/unlocking state of the door-lock apparatus. For example, when the information about the object is identical to the information about the reference object, the door-lock apparatus may be converted from the locking state to the unlocking state by a door opening and closing unit. When the information about the object is not identical to the information about the reference object, the door-lock apparatus may be maintained in the locking state by the door opening and closing unit, and may transmit the information about the object to a user terminal through a communication unit which communicates with an AP which is placed within a predetermined range.

Herein, the memory and the controller may be simultaneously or successively activated in response to determining that the object appears in front of the door-lock apparatus.

FIG. 8 is a block diagram illustrating a configuration of a door-lock apparatus when information about a reference object is stored according to an exemplary embodiment of the inventive concept.

Referring to FIG. 8, a process of storing information about a reference object according to an exemplary embodiment of the inventive concept will be described using a structure of a door-lock apparatus according to an exemplary embodiment of the inventive concept. According to an exemplary embodiment of the inventive concept, the door-lock apparatus may include a CIS 811 and an ISP 812 as a camera module 810. The door-lock apparatus may include a detector 821, a memory 822, and a controller 823 as a module 820 for object recognition. The door-lock apparatus may include a door opening and closing unit 830 which converts the door-lock apparatus from a locking state to an unlocking state and a communication unit 840, which are controlled by the controller 823. The scope and spirit of the inventive concept may not be limited thereto. For example, the scope and spirit of the inventive concept may be applied to various embodiments of the inventive concept.

Hereinafter, it is assumed that the module 820 for object recognition is activated by the camera module 810 in the process of storing the information about the reference object. For example, the module 820 for object recognition may be automatically activated by the camera module 810 through the above-described process. Alternatively, the module 820 for object recognition may be activated in response to an operation of proximity sensor included in the door-lock apparatus or a push of a user on a switch (e.g., a button for performing a process of registering users) included in the door-lock apparatus.

The CIS 811 may capture a user may obtain an optical signal for the user, and may convert the obtained optical signal into a digital image signal.

The ISP 812 may process the digital image signal to generate image data.

As such, after the process of capturing the user is completed, the detector 821 may detect information about a reference object form the image data for the user. Herein, the information about the reference object may mean information (e.g., a shape, a size, and a position of each of eyes, a nose, a mouth, and ears) about a face of the user.

In this case, the detector 821 may receive input, in which the detected information of the reference object is identified, from the user and may transmit the detected information about the reference object to the memory 822. For example, the detector 821 may detect the information about the reference object from the image data, may display the detected information about the reference object and a selection input window for asking the user whether he or she captures himself or herself again or stores the information about the reference object, and may receive selection input from the user. In the process of receiving input, in which the detected information about the reference object is identified, from the user, when user input for requesting to capture the user again is received, the detector 821 may perform the process of capturing the user once more. Also, when information about a reference object is not detected form the image data, the detector 821 may automatically perform the process of capturing the user.

After the detector 821 receives the input, in which the detected information about the reference object is identified, from the user, the memory 822 may store and maintain the information about the reference object, which is transmitted from the detector 821.

The information about the reference object, which is stored in the memory 822 through the above-described processes, may be used in a process of being compared with information about an object.

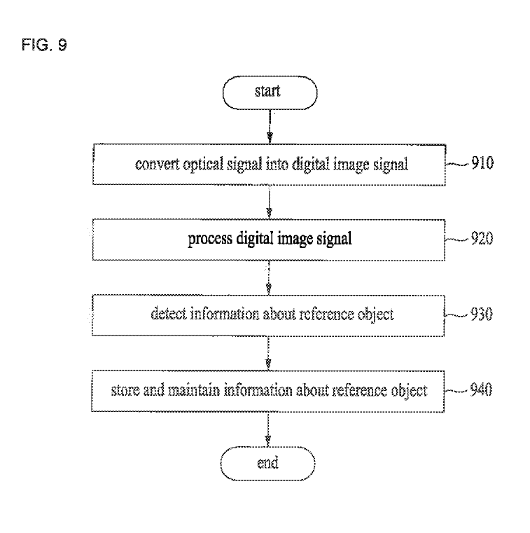

FIG. 9 is a flowchart illustrating an operation of a door-lock apparatus when information about a reference object is stored according to an exemplary embodiment of the inventive concept.

Referring to FIG. 9, a door-lock apparatus may capture a user using a camera attached to a front surface of the door-lock apparatus. In step 910, a CIS included in the door-lock apparatus may obtain an optical signal for the user and may convert the obtained optical signal into a digital image signal.

In step 920, an ISP included in the door-lock apparatus may process the digital image signal to generate image data.

As such, the process (step 910) of obtaining the optical signal for the user and converting the obtained optical signal into the digital image signal and the process (step 920) of processing the digital image signal to generate the image data for the user may mean a process of capturing the user.

In step 930, a detector included in the door-lock apparatus may detect information about a reference object form the image data for the user. Herein, the information about the reference object may mean information about a face of a registered user. In this case, the door-lock apparatus may receive input, in which the detected information of the reference object is identified, from the user and may transmit the detected information about the reference object to a memory included in the door-lock apparatus.

In step 940, the door-lock apparatus may store and maintain the information about the reference object in the memory.

According to exemplary embodiments of the inventive concept, the door-lock apparatus may usually maintain the low power mode for operating only the camera module, and may operate in a normal mode by automatically activating the module for object recognition when an object appears in front of the door-lock apparatus.

According to exemplary embodiments of the inventive concept, the door-lock apparatus may control its locking/unlocking state according to a selective operation of the module for object recognition.

According to exemplary embodiments of the inventive concept, the door-lock apparatus may include the camera module configured with at least one of the CIS, the ISP, or the detector.

According to exemplary embodiments of the inventive concept, the door-lock apparatus may determine that an object appears in front of the door-lock apparatus, using at least one of the camera module, the switch, or the proximity sensor.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

What is claimed is:

1. A door-lock apparatus based on a battery, comprising:
a complementary metal oxide semiconductor (CMOS) image sensor (CIS) configured to obtain an optical signal and to convert the obtained optical signal into a digital image signal, the CMOS image sensor attached to a front surface of the door-lock apparatus;
an image signal processor (ISP) configured to process the digital image signal to generate image data;
a detector configured to be activated according to an operation of the ISP and to detect information about an object from the image data;
a memory configured to store and maintain information about a reference object;
a controller configured to compare the information about the object with the information about the reference object and to control a locking/unlocking state of the door-lock apparatus; and
a door opening and closing unit configured to be controlled by the controller and to convert the door-lock apparatus from the locking state to the unlocking state.

2. The door-lock apparatus of claim 1, wherein each of the memory and the controller is activated according to at least one of an operation of the ISP or an operation of the detector.

3. The door-lock apparatus of claim 1, wherein the ISP comprises an ISP memory configured to store and maintain previous image data generated by the ISP, and
wherein the detector is activated in response to receiving a result signal of comparing the image data generated by the ISP with the previous image data stored in the ISP memory from the ISP.

4. The door-lock apparatus of claim 1, wherein the ISP comprises an ISP memory configured to store and maintain image data for a background image, and
wherein the detector is activated in response to receiving a result signal of comparing the image data generated by the ISP with the image data for the background image, which are stored in the ISP memory, from the ISP.

5. The door-lock apparatus of claim 1, wherein the detector is activated according to an operation of a proximity sensor included in the door-lock apparatus.

6. The door-lock apparatus of claim 1, wherein each of the CIS and the ISP is activated in response to a push of a user on a switch included in the door-lock apparatus.

7. The door-lock apparatus of claim 1, wherein when the information about the object is identical to the information about the reference object, the controller converts the door-lock apparatus from the locking state to the unlocking state using the door opening and closing unit.

8. The door-lock apparatus of claim 1, further comprising:
a communication unit configured to communicate with an access point (AP) which is placed within a predetermined range of the door-lock apparatus,
wherein when the information about the object is not identical to the information about the reference object, the controller transmits the information about the object to a user terminal through the communication unit.

9. The door-lock apparatus of claim 1, further comprising:
an infrared emitting diode (IRED) configured to emit light such that the CIS processes an infrared signal.

10. The door-lock apparatus of claim 9, wherein the WED is activated according to at least one of an operation of a proximity sensor included in the door-lock apparatus or a push of a user on a switch included in the door-lock apparatus.

11. A door-lock apparatus based on a battery, comprising:
a complementary metal oxide semiconductor (CMOS) image sensor (CIS) configured to obtain an optical signal and to convert the obtained optical signal into a digital image signal, the CMOS image sensor attached to a front surface of the door-lock apparatus;
an image signal processor (ISP) configured to be activated according to an operation of the CIS and to process the digital image signal to generate image data;
a detector configured to detect information about an object from the image data;
a memory configured to store and maintain information about a reference object;
a controller configured to compare the information about the object with the information about the reference object and to control a locking/unlocking state of the door-lock apparatus; and
a door opening and closing unit configured to be controlled by the controller and to convert the door-lock apparatus from the locking state to the unlocking state.

12. The door-lock apparatus of claim 11, wherein the detector is activated according to at least one of an operation of the CIS or an operation of the ISP, and
wherein each of the memory and the controller is activated according to at least one of an operation of the CIS or an operation of the detector.

13. The door-lock apparatus of claim 11, wherein the CIS comprises a CIS memory configured to store and maintain a previous digital image signal converted by the CIS, and
wherein the ISP is activated in response to receiving a result signal of comparing the digital image signal converted by the CIS with the previous digital image signal stored in the CIS memory from the CIS.

14. The door-lock apparatus of claim 11, wherein the CIS comprises a CIS memory configured to store and maintain a digital image signal for a background image, and
wherein the ISP is activated in response to receiving a result signal of comparing the digital image signal converted by the CIS with the digital image signal for the background image, which is stored in the CIS memory, from the CIS.

15. The door-lock apparatus of claim 11, wherein the ISP is activated according to an operation of a proximity sensor included in the door-lock apparatus.

16. The door-lock apparatus of claim 11, wherein the CIS is activated in response to a push of a user on a switch included in the door-lock apparatus.

17. The door-lock apparatus of claim 11, wherein each of the memory and the controller is activated according to an operation of the detector, and wherein the CIS and the ISP maintain an activated mode and bypass an image signal to the detector when the CIS and the ISP do not include any detection function.

18. A door-lock apparatus based on a battery, comprising:
a complementary metal oxide semiconductor (CMOS) image sensor (CIS) configured to obtain an optical signal and to convert the obtained optical signal into a digital image signal, the CMOS image sensor attached to a front surface of the door-lock apparatus;
an image signal processor (ISP) configured to process the digital image signal to generate image data;
a detector configured to detect information about an object from the image data;
a memory configured to store and maintain information about a reference object;
a controller configured to compare the information about the object with the information about the reference object and to control a locking/unlocking state of the door-lock apparatus; and
a door opening and closing unit configured to be controlled by the controller and to convert the door-lock apparatus from the locking state to the unlocking state,
wherein each of the memory and the controller is activated according to an operation of the detector.

19. The door-lock apparatus of claim 18, wherein the ISP comprises an ISP memory configured to store and maintain previous image data generated by the ISP, and
wherein the detector is activated in response to receiving a result signal of comparing the image data generated by the ISP with the previous image data stored in the ISP memory from the ISP.

20. The door-lock apparatus of claim 18, wherein the ISP comprises an ISP memory configured to store and maintain image data for a background image, and
wherein the detector is activated in response to receiving a result signal of comparing the image data generated by the ISP with the image data for the background image, which are stored in the ISP memory, from the ISP.
